(19) United States
(12) Patent Application Publication
(10) Pub. No.: US 2009/0271316 A1
(43) Pub. Date: Oct. 29, 2009

(54) Mailing kiosk with safeguards and methods of use

(76) Inventor: Stephen L. Kranyec, League City, TX (US)

Correspondence Address: John R. Casperson, PO Box 36369, Pensacola, FL, 32516, US

(21) Appl. No.: 12/381,153

(22) Filed: Mar. 6, 2009

Related U.S. Application Data
(62) Division of application No. 10/991,159, filed on Nov. 17, 2004, now abandoned.
(60) Provisional application No. 60/523,412, filed on Nov. 17, 2003.
(60) Provisional application No. 60/523,413, filed on Nov. 17, 2003.
(60) Provisional application No. 60/523,414, filed on Nov. 17, 2003.
(60) Provisional application No. 60/523,415, filed on Nov. 17, 2003.

(51) Int. Cl. G07B 17/02; G06Q 20/00

(52) U.S. Cl. 705/44; 705/404; 705/406; 705/407; 705/411

(57) ABSTRACT

A self service kiosk for mailing prohibited items from TSA checkpoints has the following features: an easy-to-touch screen, full computerization, visual and auditory prompts, clearly displayed shipping options, an automatically calculated price, an instantly-produced address/postage label and payment receipt, secure credit card processing, daily emptying by the USPS, transaction logging and cumulative accounting reports, built in communications and UPS backup, built in security features, built in slot for mail acceptance, provision of US Priority and Express Mail service, and a heavy duty plate steel vault for security.

### CROSS REFERENCES TO RELATED APPLICATIONS

This application is a division and claims the benefit of application Ser. No. 10/991,159 filed Nov. 17, 2004, which claimed the benefit of United States provisional application Ser. No. 60/523,412 filed Nov. 17, 2003, United States provisional application Ser. No. 60/523,413 filed Nov. 17, 2003, United States provisional application Ser. No. 60/523,414 filed Nov. 17, 2003, and United States provisional application Ser. No. 60/523,415 filed Nov. 17, 2003, the disclosures of which are incorporated by reference herein.

### FIELD OF THE INVENTION

In one aspect, the invention relates to a kiosk which provides mailing and/or shipment services for personal articles. In another aspect, the invention relates to a method for mailing or shipping a personal article.

### BACKGROUND OF THE INVENTION

Mail boxes have been removed from airports because it has not been possible heretofore to economically secure them against receiving bombs.

At the same time, airport security (TSA) prohibits passengers from entering airport boarding areas with TSA-prohibited items in their possession. Many of these items are confiscated or discarded, because there are no other options if the passenger wishes to board their scheduled flight.

A mailbox which could be reasonably secured against being a bomb depository placed near the TSA checkpoint would be very desirable for passengers, as many of the TSA-prohibited items could be mailed to an address selected by the user.

It is an object of the invention to provide a mailing kiosk which meets this need.

### SUMMARY OF THE INVENTION

In one embodiment of the invention, there is provided a kiosk. The kiosk comprises a vault, a gate, an actuator for the gate, an electronic display, and a computer. The vault defines a depository for storing items to be mailed and a passage leading from an outside of the depository to an inside of the depository. The gate is associated with the passage and is movable from a first position in which the passage is blocked to a second position in which the passage is open. The electronic display means is for displaying a plurality of queries and instructions to a user of the kiosk and for receiving a plurality of responses to the queries from the user. The computer is for transmitting the queries to the display means, processing the responses to the queries from the user, and selectively signaling the actuator to move the gate from the first position to the second position.

In another embodiment of the invention, there is provided an improvement to a mailing kiosk having a storage area for storing items to be mailed and an access slot to permit items to be deposited into the storage area and to resist the withdrawal of items from the storage area. The improvement is for restricting the deposit of items which are larger than letters and comprises a gate and an electronically actuated means for moving the gate. The gate is positioned across the access slot and is movable from a first position which blocks the deposit of items larger than letters into the storage area to a second position which permits the deposit of items into the storage area which are larger than letters but beneath a predetermined upper thickness. The electronically actuated means is for moving the gate from the first position to the second position for a predetermined period of time.

In another embodiment of the invention, there is provided an improved method for providing self-service kiosk services. The method comprises providing a self-service kiosk for a user to mail items larger or heavier than letters. The kiosk includes a depository for the items and a passage leading to the depository. The improvement comprises blocking the passage with an electronically controlled door, the door being normally in a closed position, displaying at least one query to the user on a display device associated with the kiosk, and selectively opening the door in response to user input to the at least one query.

In a further embodiment of the invention, there is provided another method for providing self-service kiosk services. The method is carried out by providing a self-service kiosk for a user to purchase postage. The kiosk includes a printer for printing the postage and an electronic display device for displaying instructions for using the kiosk. The improvement comprises displaying at least one query to the user on a display device, and selectively printing the postage in response to user input to the at least one query.

### BRIEF DESCRIPTION OF THE DRAWINGS

FIG. 1 is a pictorial representation of a mailing kiosk according to one embodiment of the invention.

FIG. 2 is a pictorial representation of a kiosk as in FIG. 1 with opened covers to show internal details.

FIG. 3 is a detailed view of a portion of the kiosk shown in FIGS. 1 and 2 in one configuration.

FIG. 4 is a sectional view of a portion of the kiosk in one configuration taken along lines 4-4 in FIG. 1.

FIG. 5 is a sectional view of the kiosk portion shown in FIG. 3 along lines 5-5.

FIG. 6 is a detailed view of the portion of the kiosk shown in FIG. 3 in another configuration.

FIG. 7 is a detailed view of the portion of the kiosk shown in FIG. 4 in another configuration.

FIGS. 8A and 8B represent a logic flow chart for operation of the kiosk.

FIG. 9 is a schematic of the kiosk modules linked by communication paths.

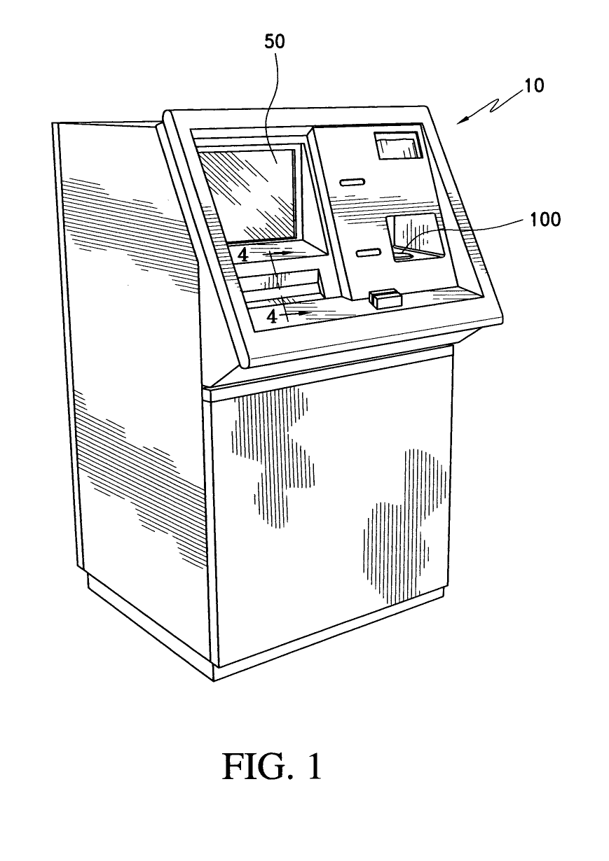

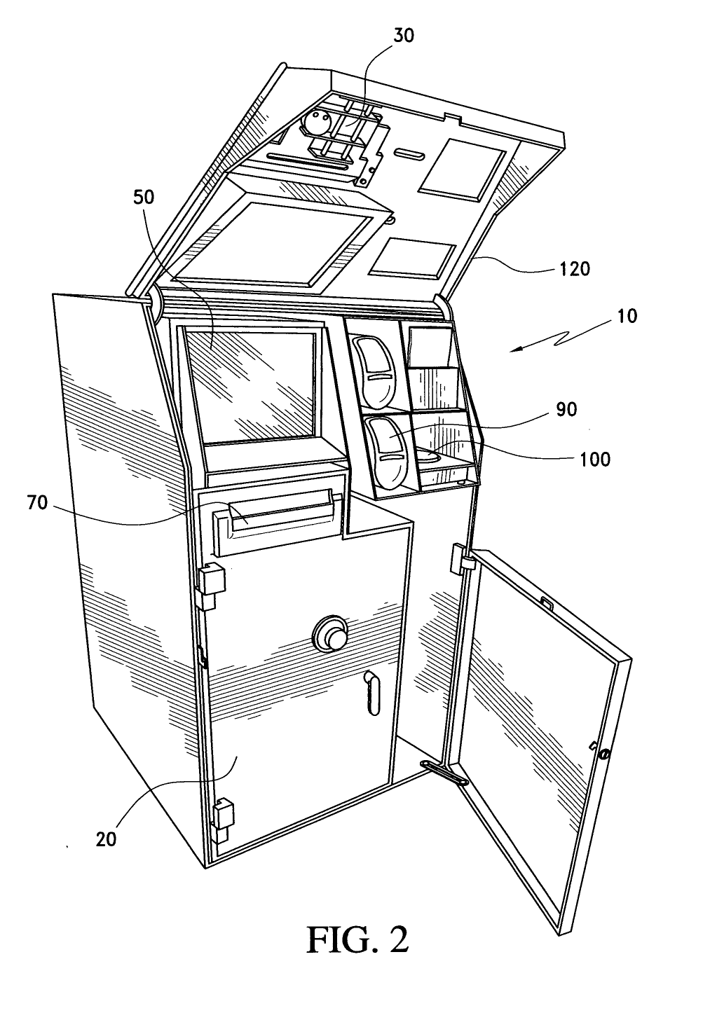

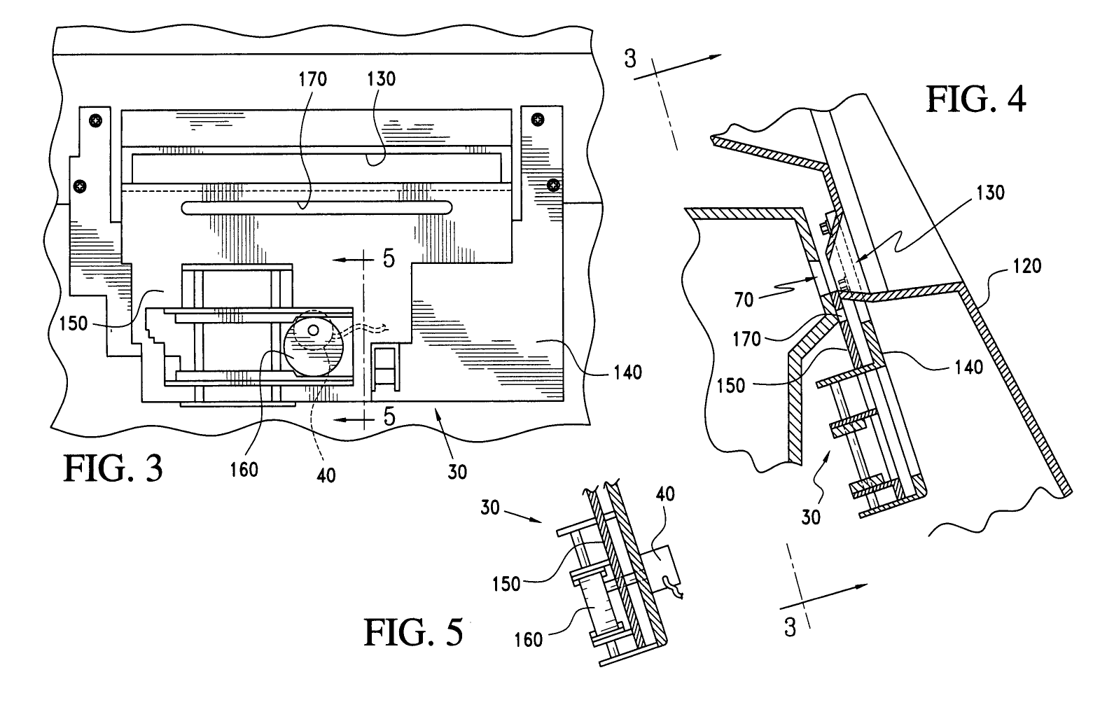

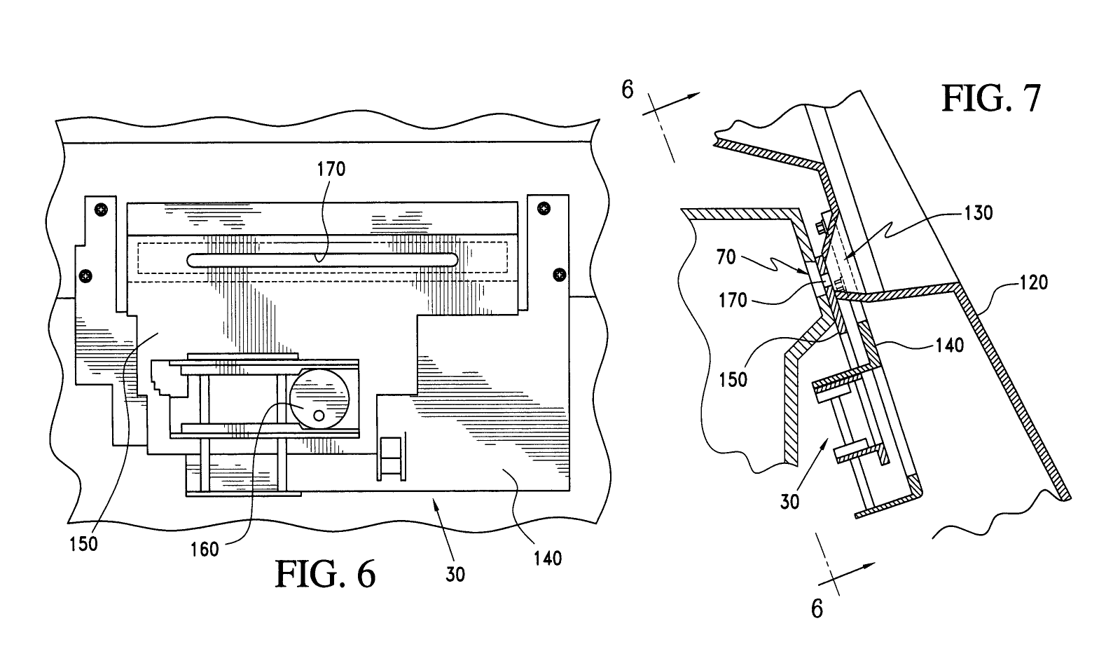

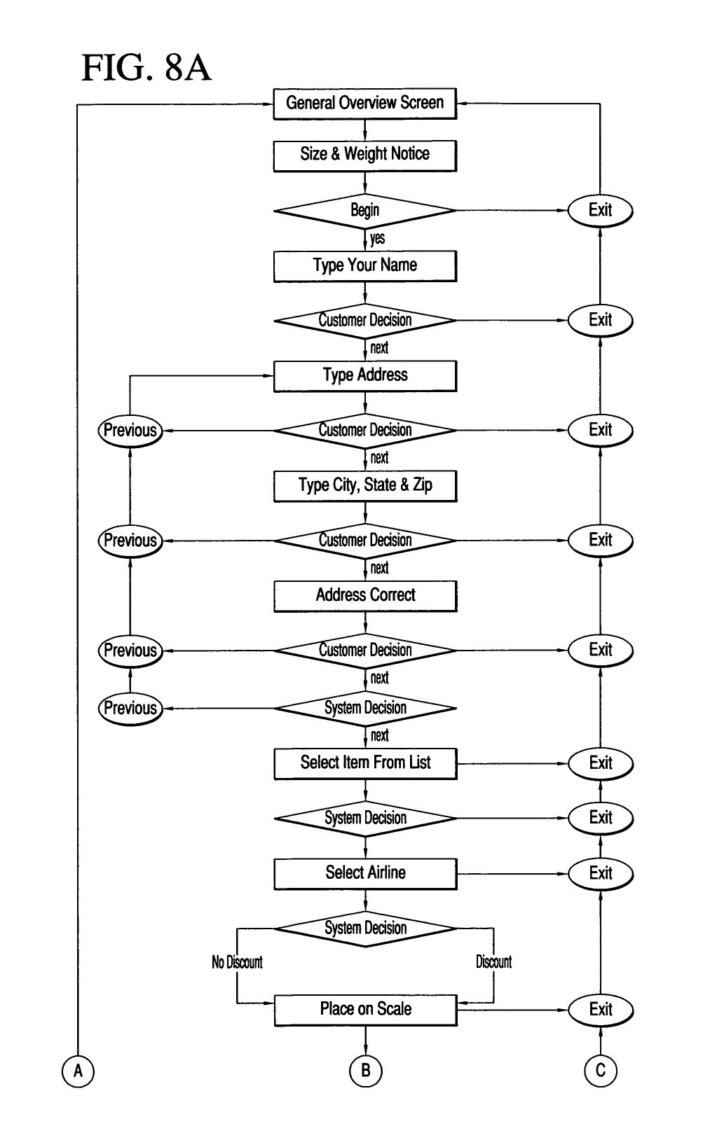

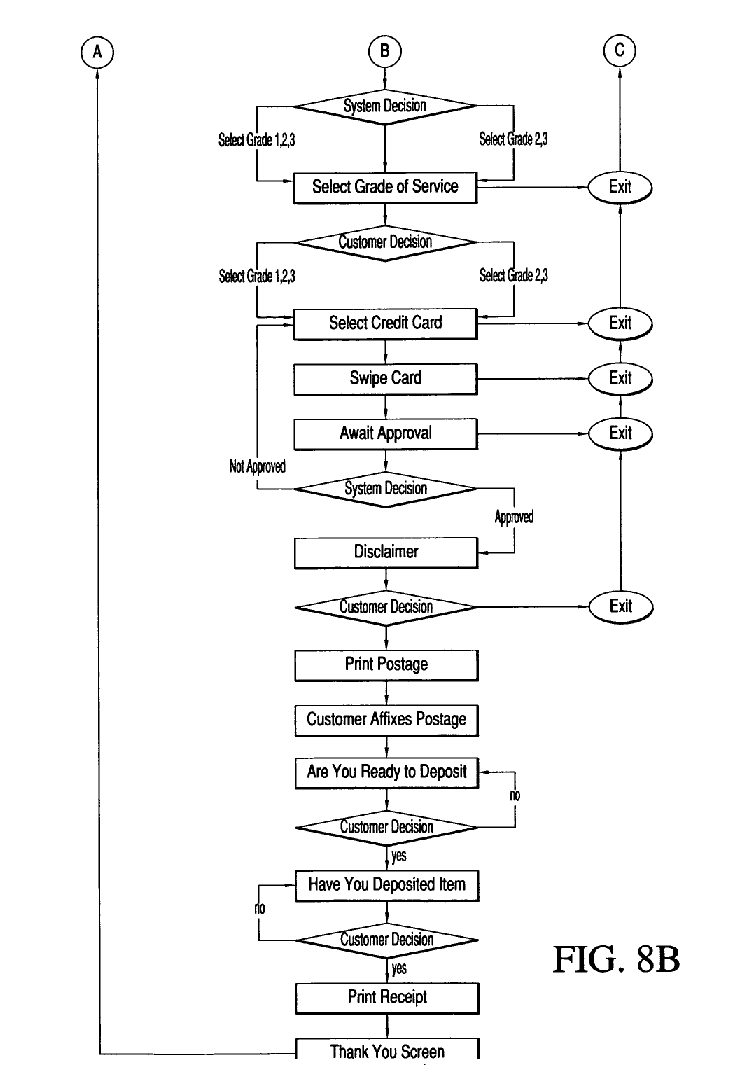

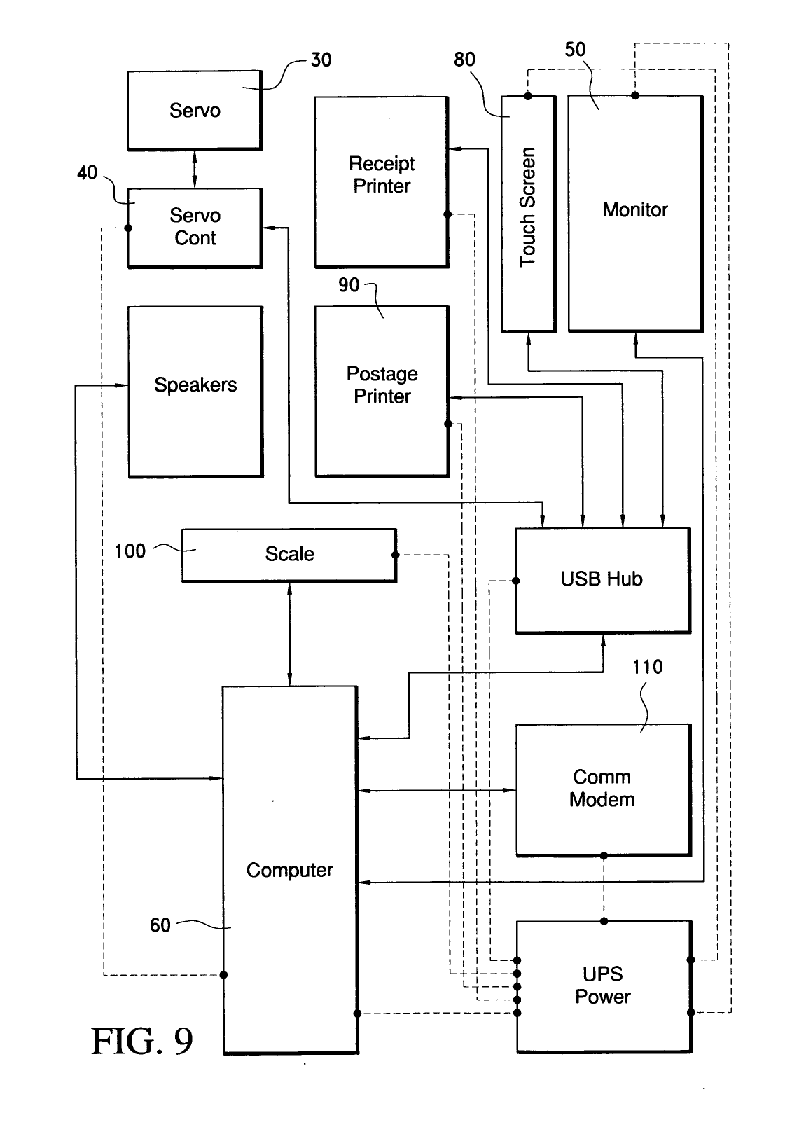

### DETAILED DESCRIPTION OF THE INVENTION

### Exemplary embodiments

In one exemplary embodiment of the invention, there is provided a kiosk 10 comprising a vault 20, a gate 30, an actuator 40 for the gate, an electronic display 50, and a computer 60. The vault defines a depository for storing items to be mailed and a passage 70 leading from an outside of the depository to an inside of the depository. The gate is associated with the passage and is movable from a first position (FIG. 7) in which the passage is blocked to a second position (FIG. 4) in which the passage is open. The electronic display means is for displaying a plurality of queries to a user of the kiosk and for receiving a plurality of responses to the queries from the user. The computer is for transmitting the queries to the display means, processing the responses to the queries from the user, and selectively signaling the actuator to move the gate from the first position to the second position.

Preferably, the computer further signals the actuator to move the gate from the second position to the first position after the passage of a predetermined period of time. Also preferably, the computer further times out a query in the event that a response is not received from the user after the passage of the predetermined period of time.

The kiosk preferably further comprises instructions for causing the computer to display, on the display means, a list of items, and a request for the user to select the item which best identifies the item sought to be mailed by the user, and instructions for causing the computer to render the kiosk unusable for a predetermined period of time by a user who has indicated that the item sought to be mailed is an item prohibited for mailing by the US Postal Service.

The electronic display means for displaying the plurality of queries and for receiving the responses preferably comprises a touch-screen user interface 80 operably associated with the computer.

The actuator preferably comprises a logic card in operable association with the computer and a servo motor, and instructions for causing the computer to process the responses to the queries, and, upon determining that the responses meet predetermined criteria, to signal the logic card to actuate the servo motor and open the passage. The predetermined criteria preferably include at least one of an input by the user of a valid mailing address, an input by the user of a valid selection of an item identification the mailing of which is not prohibited, and an input by the user of valid electronic payment information.

The kiosk preferably further comprises a printer 90 for printing an address label operably associated with the computer, and instructions to cause the computer to signal the printer to print the address label. The instructions preferably cause the printer to be signaled only after determining that certain predetermined criteria have been met. The predetermined criteria preferably include input of an address in a valid format, confirmation that the address is valid, an input by the user of a valid selection of an item identification the mailing of which is not prohibited, and an input by the user of valid electronic payment information.

An electronic scale 100 is further preferably operably associated with the computer. The computer is preferably provided with instructions to cause the computer to signal the touch screen to display a request for the user to place the item to be mailed on the electronic scale, instructions to cause the computer to calculate and display, on the touch screen, classes of mailing service offered for the item and associated amount due and a request for the user to select the class of mailing service desired.

The kiosk preferably further comprises instructions to cause the computer to signal the touch screen to display a prompt to the user to make electronic payment, and a means operably associated with the computer for accepting an electronic payment authorization for the amount due.

In one embodiment of the invention, a communications modem 110 is operably associated with the computer. A mailing address database is accessible via the communications modem from the computer. The computer is provided with instructions to cause the computer to query the mailing address database to determine whether the mailing address entered by the user in response to the query is a valid mailing address according to the database. Preferably, the computer is further provided with instructions to cause the computer to transmit the mailing address entered by the user offsite for storage.

In one embodiment of the invention, certain mailing addresses are flagged in the database, and a code is transmitted to the kiosk where the mailing address entered by the user corresponds to a flagged address. The kiosk is preferably further provided with instructions for causing the computer to render the kiosk unusable for a predetermined period of time to such user.

If the mailing address is flagged for security and/or criminal activity concerns, airport security personnel or other law enforcement agency can further be notified.

In a further embodiment of the invention, an electronic payment database is accessible via the communications modem from the computer. The computer is provided with instructions to cause the computer to query the electronic payment database to determine whether the electronic payment is authorized according to the database.

In a further embodiment of the invention, a printer for printing postage is operably associated with the computer, and the computer is provided with instructions to cause the computer to signal the printer to print the postage, provided that the electronic payment is authorized according to the database. The printer can be the same as is used to print address labels.

In a further embodiment of the invention, an electronic camera is operably associated with the computer. The computer is provided with instructions to cause the computer to actuate the camera and capture an image of the user.

In a further embodiment of the invention, the kiosk is further provided with instructions to cause the computer to display on the touch screen, a release of liability, for the user to accept or decline. Preferably, the electronic camera captures an image of the user in response to the user accepting the release of liability. Additionally, it is preferred that the computer be provided with instructions to cause the computer to transmit the image of the user to an off-site location for storage.

In another embodiment of the invention, there is provided an improvement to a mailing kiosk having a storage area for storing items to be mailed and an access slot to permit items to be deposited into the storage area and to resist the withdrawal of items from the storage area. The improvement is for restricting the deposit of items which are larger than letters and comprises a gate and an electronically actuated means for moving the gate. The gate is positioned across the access slot and is movable from a first position which blocks the deposit of items larger than letters into the storage area to a second position which permits the deposit of items into the storage area which are larger than letters but beneath a predetermined upper thickness. The electronically actuated means is for moving the gate from the first position to the second position for a predetermined period of time.

The electronically actuated means preferably includes a user interface, a computer, and an actuator. The least one user interface is for displaying queries and instructions to a user of the kiosk and permitting the user to input data responsive to the queries and instructions. The computer is provided with operative instructions for displaying queries and instructions on the user interface, receiving and processing the user input data, and producing a signal for causing the gate to be moved from the first position to the second position. The actuator is for receiving the signal from the computer and moving the gate from the first position to the second position responsive to the signal.

Preferably, the mailing kiosk further comprises a vault and a housing 120. The vault defines the storage area and further defines an inner slot leading into the storage area. The housing at least partially surrounds the vault and defines an outer slot 130 leading into the storage area. The outer slot is in alignment with the inner slot 70. The gate 30 is positioned between the outer slot and the inner slot.

The gate 30 preferably comprises a carrier plate 140, a movable gate plate 150, a cam 160, and the servo motor 40. The movable gate plate is mounted alongside the carrier plate for movement in a plane parallel to the carrier plate. The cam is rotatably mounted to the carrier plate for urging the gate plate from the first position to the second position. The servo motor is mounted to the carrier plate for driving the cam. More preferably, the gate defines a slot 170 incapable of accepting items having a thickness of over 0.5 cm which is in-alignment with the inner slot and the outer slot when the gate is in the first position and the gate is out of blocking alignment with the inner slot and the outer slot when the gate is in the second position.

In one embodiment, the least one user interface includes a scale. The computer instructions require user input of a valid mailing address, user indication of a non-prohibited item to be mailed, input of a weight from the scale that is within mailing limits, user selection of a valid class of mailing for the item, user input of electronic payment information, and user acceptance of a release of liability, prior to signaling the signaling the actuator to move the gate from the first position to the second position.

In another embodiment of the invention, there is provided an improved method for providing self-service kiosk services. The method comprises providing a self-service kiosk for a user to mail items larger or heavier than letters. The kiosk includes a depository for the items and a passage leading to the depository. The improvement comprises blocking the passage with an electronically controlled door, the door being normally in a closed position, displaying at least one query to the user on a display device associated with the kiosk, and selectively opening the door in response to user input to the at least one query.

Preferably, the step of displaying the at least one query includes displaying a request for the user to input the user's address information, receiving the address information from the user, displaying the address information and a request for the user to confirm that the address information is a correct, receiving a confirmation from the user, and determining whether or not the user address matches a mailing address in a database.

More preferably, the user address is transmitted to a remote site over the internet and stored the user address at the remote site in a computer memory device.

If the user address matches the mailing address in the database an electronic impediment to opening the door is overcome. If the user address fails to match a mailing address in the database and an electronic impediment to opening the door remains in place. Optionally, the kiosk can be rendered inoperable to the user for a predetermined period of time if the user address does not match the address in the database.

Preferably, the step of determining includes transmitting the input address information over the internet to a remote computer, the remote computer having access to the database, the database comprising a list of valid mailing addresses, comparing the input address information to the address information in the database, determining, in the remote computer, whether or not the user address matches a mailing address in the database, and transmitting the determination to the kiosk.

Optionally, it can be determined in the in the remote computer whether or not the user name matches a name in a watch list, and, in the event the user name matches a name on the watch list the determination can be transmitted over the internet to a Federal Agency.

In a preferred embodiment, the steps of displaying a request for the user to input the user's address information and receiving the address information from the user includes displaying a request for a user to input the user's name, receiving a name input from the user, displaying a request for the user to input the user's address, receiving an address input from the user, displaying a request for the user to input the user's city, state and zip code, and receiving city, state and zip code data from the user.

The step of displaying the at least one query includes displaying a request for the user to provide an indication of the identity of the item to be mailed, and receiving an indicated identity of the item to be mailed from the user. If the indicated item is not prohibited from mailing by the United States Postal Service or other carrier servicing the kiosk, an electronic impediment to opening the door is overcome. If the indicated item is prohibited from mailing by the United States Postal Service or other carrier servicing the kiosk, an electronic impediment to opening the door remains in place. Optionally, in such case, the kiosk can be rendered unusable by the user for a predetermined period of time.

In a preferred embodiment, the step of displaying the at least one query includes displaying a request for the user to place the item on a scale, and, where the user places the item on the scale, receiving an indication of item weight from the scale, and determining whether or not the item exceeds a predetermined weight.

If the weight of the item does not exceed the predetermined weight, an electronic impediment to opening the door is removed. If the weight of the item exceeds the predetermined weight an electronic impediment to opening the door remains in place.

In a preferred embodiment, the step of displaying the at least one query includes displaying a request for the user to select a class of mailing service, receiving an indication of class of mailing service from the user, displaying a request for the user to input electronic payment information, and receiving the electronic payment information from the user. The electronic payment information is transmitted over the internet to a clearance center, and an approval or a rejection of the electronic payment information is received from the clearance center. If an approval is received from the clearance center, an electronic impediment to opening the door is overcome. If a rejection is received from the clearance center, the electronic impediment to opening the door remains in place.

In a preferred embodiment, the step of displaying at least one query includes displaying a request for the user to accept a release of liability. Receipt of an input from the user indicating acceptance of the release of liability overcomes an electronic impediment to opening the door. The process preferably further comprises capturing an image of the user, and transmitting the image offsite via the internet.

The method preferably further involves displaying a welcome screen. The welcome screen can be activated by user action or, after passage of a predetermined period of time, user inaction. Also, it is preferred that the door be closed a predetermined period of time after it has been opened.

In a further aspect of the invention, there is provided another method for providing self-service kiosk services. The method is carried out by providing a self-service kiosk for a user to purchase postage. The kiosk includes a printer for printing the postage and an electronic display device for displaying instructions for using the kiosk. The improvement comprises displaying at least one query to the user on a display device, and selectively printing the postage in response to user input to the at least one query.

The step of displaying the at least one query includes displaying a request for the user to input the user's address information, receiving the address information from the user, displaying the address information and a request for the user to confirm that the address information is a correct, receiving a confirmation from the user, and determining whether or not the user address matches a mailing address in a database. It is further preferred to transmit the user address to a remote site over the internet, and store the user address at the remote site in a computer memory device. If the user address matches the mailing address in the database, an electronic impediment to printing the postage is overcome. If the user address fails to match a mailing address in the database, the electronic impediment to printing the postage remains in place. Further, the kiosk can be rendered unusable by that user for a predetermined period of time.

The step of determining preferably includes transmitting the input address information over the internet to a remote computer. The remote computer has access to the database. The database comprises a list of valid mailing addresses. The input address information is compared to the address information in the database. It is then determined in the remote computer whether or not the user address matches a mailing address in the database. This determination is transmitted to the kiosk.

It is further preferred, in the remote computer, to determine whether or not the user name matches a name in a watch list. In the event that the user name matches a name on the watch list, the determination can be transmitted, over the internet, to a Federal Agency.

Preferably, the steps of displaying a request for the user to input the user's address information and receiving the address information from the user includes displaying a request for a user to input the user's name, receiving a name input from the user, displaying a request for the user to input the user's address, receiving an address input from the user, displaying a request for the user to input the user's city, state and zip code, and receiving city, state and zip code data from the user.

The step of displaying the at least one query can include displaying a request for the user to provide an indication of the identity of the item to be mailed, and receiving an indicated identity of the item to be mailed from the user. If the indicated item is not prohibited from mailing by the United States Postal Service, an electronic impediment to printing the postage is overcome. If the indicated item is prohibited from mailing by the United States Postal Service an electronic impediment to printing the postage remains in place. Further, the kiosk can be rendered unusable to the user for a predetermined period of time.

The step of displaying the at least one query can include displaying a request for the user to place the item on a scale, receiving an indication of item weight from the scale if the user has placed the item on the scale, and determining whether or not the item exceeds a predetermined weight. If the weight of the item does not exceed the predetermined weight, an electronic impediment to printing the postage is removed. If the weight of the item exceeds the predetermined weight an electronic impediment to printing the postage remains in place.

Preferably, the step of displaying the at least one query includes displaying a request for the user to select a class of mailing service, receiving an indication of class of mailing service from the user, displaying an amount due from the user based on the indication of class of mailing service from the user, displaying a request for the user to input electronic payment information for the amount due, and receiving the electronic payment information from the user. The electronic payment information can further be transmitted over the internet to a clearance center, and an approval or a rejection of the electronic payment information received back from the payment center. If an approval is received from the clearance center, an electronic impediment to printing the postage is overcome. If a rejection is received from the clearance center, the electronic impediment to printing the postage remains in place.

The step of displaying at least one query preferably includes displaying a request for the user to accept a release of liability. If an input is received from the user indicating acceptance of the release of liability, an electronic impediment to printing the postage is overcome. Additionally, an image of the user can be captured and transmitting the image offsite via the internet.

Further in a preferred embodiment, a welcome screen can be displayed which is actuated by user action or, after passage of a predetermined period of time, user inaction.

### Preferred Embodiments

In a preferred embodiment of the invention, a self service kiosk for mailing prohibited items from TSA checkpoints has the following features: an easy-to-touch screen, full computerization, visual and auditory prompts, clearly displayed shipping options, an automatically calculated price, an instantly-produced address/postage label and payment receipt, secure credit card processing, daily emptying by the USPS, transaction logging and cumulative accounting reports, built in communications and UPS backup, built in security features, built in slot for mail acceptance, provision of US Priority and Express Mail service, and a heavy duty plate steel vault for security.

It is preferred that the package depository be an actual vault of hardened steel that meets or exceeds Federal Reserve standards, has a weight of at least 1200 pounds, has a size-limited depository opening no larger than 1″ by 9″ which is accessible only via an electronically controlled door, is provided with downwardly directed vents for bomb resistance, and is normally kept in a locked condition with extremely limited authorized access.

It is further preferred that use of the device be made contingent the user's entering an acceptable classification of the article to be shipped or mailed and an acceptable address. An acceptable classification by the user of the article to be shipped, for example, would be classification of the article in other than on a prohibited list. An acceptable address, for example, would be an address matching US Postal Service records. The records database is preferably kept up-to-date at a remote site and is preferably near instantly accessible via a communications package provided with the device. Similarly, the credit card payments for use of the device are preferably verified at a remote up-to-date database via the communications package.

Additionally, it is preferred that use of the device be made contingent on the article being within weight and size limits, for example, no more than one pound in weight or greater than one inch in thickness.

Further, it is preferred that the device be deployed in a supervised area, such as within view of a TSA checkpoint in an airport, preferably between the ticket counter and the TSA checkpoint, and that it be emptied on a scheduled basis at least once daily.

Description of Screens in most Preferred Embodiment

A first screen displays instructions for a user to enter their name. There is further displayed on the view screen a window to display an image of user name data input by the user from a keyboard. The view screen further comprises an interactive touch screen and there is further displayed on the screen an image of the keyboard and buttons to advance to the next screen or exit the procedure. The screen further preferably displays a button labeled NEXT and a button labeled EXIT.

A second screen displays instructions for the user to enter their street address. There is further displayed on the view screen a window to display an image of user street address data input from the keyboard. The view screen further comprises an interactive touch screen and there is further displayed on the screen an image of the key board and buttons to advance to the next screen, go back to the previous screen, or exit the procedure. The view screen preferably displays a button labeled PREVIOUS, a button labeled NEXT and a button labeled EXIT.

A third screen displays instructions for a user to enter their city, state and zip code. There is further displayed on the view screen a window to display an image of city, state and zip code data input from the keyboard. The view screen further comprises an interactive touch screen and there is further displayed on the screen an image of the keyboard and buttons to advance to the next screen, go back to the previous screen, or exit the procedure. The view screen preferably displays a button labeled PREVIOUS, a button labeled NEXT and a button labeled EXIT.

A fourth screen displays a mailing address image based on keyboard input by the user of name, street address, city, state and zip code data. A query is displayed regarding whether the mailing address image is correct. Images of buttons are displayed to advance to the next screen, go back to the previous screen, or exit the procedure.

The computer processes, the name, street address, city, state and zip code data to determine whether it meets predetermined standards for mailing,

A fifth screen displays a request on the view screen for the user to be more specific in the event that the name, street address, city, state and zip code data does not meet predetermined standards for mailing.

An off-site process compares, the user name, street address, city, state and zip code data to a database of known valid mailing addresses to determine whether the user mailing address corresponds to a mailing address in the database. The comparison further comprises transmitting the label data offsite, and comparing the label data to label data in a database. The label data is further transmitted to a police authority site in the event that it matches with data upon which a watch has been placed.

A sixth screen displays a request for the user to re-enter address information in the event that the user mailing address does not correspond to a mailing address in the database.

A seventh screen displays a list of items, and a request for the user to select the item which best identifies the item sought to be mailed by the user. Preferably, a plurality of buttons labeled with descriptive information pertaining to common items sought to be mailed are displayed. Also displayed is a button labeled EXIT. The list of items is displayed only in the event that the user mailing address corresponds to a mailing address in the database.

The computer determines whether the item identified by the user corresponds to an item prohibited for mailing by the US Postal Service.

An eighth screen displays a denial of service message in the event that the item identified by the user is prohibited for mailing. The user is preferably further prevented by the computer from again attempting to use the system based on the previously entered address for a predetermined period of time. For example, one hour in an airport setting.

A ninth screen displays instructions for weighing the item sought to be mailed on scales associated with the system. The screen preferably further displays an image of scales associated with the system. The screen preferably further displays a button labeled NEXT and a button labeled EXIT.

The instructions for weighing are displayed only in the event that the item identified by the user is not an item prohibited for mailing by the US Postal Service.

The computer determines charges to mail the item for different classes of service, based on a weight input from the scales. Handling charges are preferably included.

A tenth screen displays classes of mailing service offered for the item and a request for the user to select the class of mailing service desired. The screen further displays a plurality of buttons labeled with descriptive information pertaining to different classes of mailing service offered and associated price. The view screen preferably further displays a button labeled EXIT. The categories of mailing service screen is displayed only in the event that the weight input from the scales does not exceed a predetermined maximum for all available classes of service.

An eleventh screen displays a denial of service message in the event that the weight input from the scales exceeds a predetermined maximum for all available classes of service.

A twelfth screen displays electronic payment instructions in the event that the user selects a class of mailing service desired. Preferably, the screen further displays an image a card reader associated with the system. The view screen preferably further displays a button labeled EXIT.

A thirteenth screen preferably displays a release of liability which must be accepted or rejected by the user in the event that the user uses the card reader. The view screen further displays a button labeled I ACCEPT and a button labeled EXIT. An image of the user is captured by a camera associated with the system in the event that the user selects I ACCEPT. The image of the user is transmitted to an off-site location.

The data received by the card reader is transmitted to a clearance center for an indication of acceptance or rejection based on a comparison at the clearance center of data from the card with data in a card database.

A fourteenth screen displays, pending receipt from the card center of acceptance or rejection, a message to please wait.

A fifteenth screen displays, in the event of rejection by the card center, a message to the user that the card has been declined.

In the event of acceptance by the card center, one or more printers associated with the system prints an address label, a return address label, and a postage label.

A sixteenth screen displays instructions to affix the labels. The screen further displays a button labeled NEXT, and an instruction to touch the button labeled NEXT once the labels are affixed.

The passage to a mailing depository is opened only in response to the user touching the button labeled NEXT. The passage remains opened only for a predetermined period of time.

A seventeenth screen displays instructions for depositing the article in the mailing depository.

An eighteenth screen displays a query to the user regarding whether the user has completed the deposit. The screen preferably further displays a button labeled YES and a button labeled NO. The passage is closed in response to the user touching the YES button.

A nineteenth screen displays a time warning in the event the user presses the NO button. The screen preferably further displays a button labeled ITEM DEPOSITED and a button labeled IT WILL NOT FIT.

A twentieth screen displays instructions for the user to obtain a receipt.

A twenty-first screen displays instructions on further steps in response to the user touching the IT WILL NOT FIT BUTTON.

A twenty-second screen displays instructions for the user to obtain a tracking number.

While certain preferred embodiments of the invention have been described herein, the invention is not to be construed as being so limited, except to the extent that such limitations are found in the claims.

1. In a method comprising
providing a self-service kiosk for a user to purchase postage,
said kiosk including a printer for printing the postage, and an electronic display device for displaying instructions for using the kiosk,
the improvement comprising
displaying at least one query to the user on a display device, and
selectively printing the postage in response to user input to the at least one query.

2. A method as in claim 1 wherein the step of displaying the at least one query includes
displaying a request for the user to input the user's address information,
receiving the address information from the user,
displaying the address information and a request for the user to confirm that the address information is a correct,
receiving a confirmation from the user, and
determining whether or not the user address matches a mailing address in a database.

3. A method as in claim 2 further comprising
transmitting the user address to a remote site over the internet, and
storing the user address at the remote site in a computer memory device.

4. A method as in claim 2 wherein the user address matches the mailing address in the database and an electronic impediment to printing the postage is overcome.

5. A method as in claim 2 wherein the user address fails to match a mailing address in the database and an electronic impediment to printing the postage remains in place.

6. A method as in claim 2 wherein the step of determining includes
transmitting the input address information over the internet to a remote computer, said remote computer having access to the database, said database comprising a list of valid mailing addresses,
comparing the input address information to the address information in the database,
determining, in the remote computer, whether or not the user address matches a mailing address in the database, and
transmitting the determination to the kiosk.

7. A method as in claim 2 wherein the steps of displaying a request for the user to input the user's address information and receiving the address information from the user includes
displaying a request for a user to input the user's name,
receiving a name input from the user,
displaying a request for the user to input the user's address,
receiving an address input from the user,
displaying a request for the user to input the user's city, state and zip code, and
receiving city, state and zip code data from the user.

8. A method as in claim 1 wherein the step of displaying the at least one query includes
displaying a request for the user to provide an indication of the identity of the item to be mailed, and
receiving an indicated identity of the item to be mailed from the user.

9. A method as in claim 8 wherein the indicated item is not prohibited from mailing by the United States Postal Service an electronic impediment to printing the postage is overcome

10. A method as in claim 8 wherein the indicated item is prohibited from mailing by the United States Postal Service and an electronic impediment to printing the postage remains in place.

11. A method as in claim 1 wherein the step of displaying the at least one query includes
displaying a request for the user to place the item on a scale, wherein the user places the item on the scale,
receiving an indication of item weight from the scale, and
determining whether or not the item exceeds a predetermined weight.

12. A method as in claim 11 wherein the weight of the item does not exceed the predetermined weight and an electronic impediment to printing the postage is removed.

13. A method as in claim 11 wherein the weight of the item exceeds the predetermined weight and an electronic impediment to printing the postage remains in place.

14. A method as in claim 1 wherein the step of displaying the at least one query includes
displaying a request for the user to select a class of mailing service
receiving an indication of class of mailing service from the user,
displaying an amount due from the user based on the indication of class of mailing service from the user,
displaying a request for the user to input electronic payment information for the amount due, and
receiving the electronic payment information from the user.

15. A method as in claim 14 further comprising
transmitting the electronic payment information over the internet to a clearance center, and
receiving from the clearance center an approval or a rejection of the electronic payment information.

16. A method as in claim 1 wherein the step of displaying at least one query includes
displaying a request for the user to accept a release of liability,
wherein receipt of an input from the user indicating acceptance of the release of liability overcomes an electronic impediment to printing the postage.

17. A method as in claim 16 further comprising
capturing an image of the user, and
transmitting the image offsite via the internet.

18. A method as in claim 1 further comprising
displaying a welcome screen which is actuated by user action or, after passage of a predetermined period of time, user inaction.

19. In a mailing kiosk having a storage area for storing items to be mailed and an access slot to permit items to be deposited into the storage area and to resist the withdrawal of items from the storage area, the improvement for restricting the deposit of items which are larger than letters comprising
a gate positioned across the access slot and movable from a first position which blocks the deposit of items larger than letters into the storage area to a second position which permits the deposit of items into the storage area which are larger than letters but beneath a predetermined upper thickness,
and electronically actuated means for moving the gate from the first position to the second position for a predetermined period of time.

20. A mailing kiosk as in claim 19 wherein the electronically actuated means includes
at least one user interface for displaying queries and instructions to a user of the kiosk and permitting the user to input data responsive to the queries and instructions,
a computer with operative instructions for displaying queries and instructions on the user interface, receiving and processing the user input data, and producing a signal for causing the gate to be moved from the first position to the second position, and
an actuator for receiving the signal from the computer and moving the gate from the first position to the second position responsive to the signal.

21. A mailing kiosk as in claim 20 further comprising
a vault defining the storage area, said vault defining an inner slot leading into the storage area, and
a housing at least partially surrounding the vault, said housing defining an outer slot leading into the storage area, said outer slot being in alignment with the inner slot,
wherein the gate is positioned between the outer slot and the inner slot.

22. A mailing kiosk as in claim 21
wherein the gate comprises a carrier plate and
a movable gate plate mounted alongside the carrier plate for movement in a plane parallel to the carrier plate,
a cam rotatably mounted to the carrier plate for urging the gate plate from the first position to the second position, and
a servo motor mounted to the carrier plate for driving the cam.
